(19) United States
(12) Patent Application Publication
(10) Pub. No.: US 2007/0294674 A1
(43) Pub. Date: Dec. 20, 2007

(54) METHOD OF CREATION OF MULTIMEDIA CONTENTS FOR MOBILE TERMINALS, COMPUTER PROGRAM PRODUCT FOR THE IMPLEMENTATION OF SUCH A METHOD

(75) Inventors: Emmanuel Marilly, Saint-Michel-Sur-orge (FR); Gerard Delegue, Cachan (FR); Olivier Martinot, Draveil (FR); Sylvain Squedin, Bondoufle (FR); Erwan Baynaud, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/765,426

(22) Filed: Jun. 19, 2007

(30) Foreign Application Priority Data
Jun. 20, 2006 (FR) 0652172

(51) Int. Cl. G06F 9/45; G06F 9/44; G06F 17/00; G06F 3/00

(52) U.S. Cl. 717/136; 715/762; 715/700; 707/104.1; 717/106

(57) ABSTRACT

Method of creation of a multimedia service, this method comprising: a step of generic description, independent of the multimedia format, of the graphical charts employed for the service, a step of generic description, independent of the multimedia format, of the elementary services of the service; a step of merging of the generic description of the graphical charts and the generic description of the elementary services to form a generic description of the service; a step of choice of at least one target language; a step of translation of the generic description of the service into the chosen target language.

### CROSS-REFERENCE TO RELATED APPLICATIONS

This application is based on French Patent Application No. 0652172 filed Jun. 20, 2006, the disclosure of which is hereby incorporated by reference thereto in its entirety, and the priority of which is hereby claimed under 35 U.S.C. §119.

### BACKGROUND OF THE INVENTION

1. Field of the Invention

The invention concerns the creation of rich media format contents. The invention finds one application in interactive multimedia, in particular interactive television, on mobile terminals, but also TNT, IPTV.

“Multimedia” refers to the interactive and simultaneous use of a plurality of modes of representation of information (text, fixed or animated images, sound).

“Interactive” refers to the possibility of reciprocal actions in dialog mode. For example, the user can choose responses, follow his own path in a tree, modify the progress of a program.

“Interactive television” (ITV) refers here to any technology enabling two-way communication between viewers and service providers (such as broadcasters, cable TV distributors), in particular for entertainment, information, education, commerce. The services that an interactive television must offer include VoD (Video on Demand), podcasts, PVR (Personal Video Recording), ESG (Electronic Service Guide), voting, quizzes, shopping, for example.

2. Description of the Prior Art

Multimedia has been successful on the Web, especially since the launch in 1995 of the Java programming language which has enabled autonomous applications to be created and html (Hyper Text Mark-Up Language) documents to be given new functions: interactive animations, integrated applications, 3D models. This object-oriented language includes elements specifically designed for the creation of multimedia applications. For interactivity, connections that can be activated on demand (hyperlinks) link the data for Web browsing.

Internet, landline telephone and mobile telephone, radio and television are now available on computers via a single “multifunction” modem. The convergence of audiovisual, electronic data processing and telecommunications is a reality for persons owning these modems.

Interactive multimedia on mobile terminals is currently arousing great interest.

In the past, Internet access protocols specific to mobile terminals such as PDA (Personal Digital Assistants) or mobile telephones have been proposed, for example WAP (Wireless Application Protocol).

A number of standards have now been proposed for television on mobile terminals.

A first standard is the MPEG-4 BIFS.

The ISO/IEC MPEG4 (Moving Pictures and associated audio information coding Expert Group 4) standard concerns all multimedia technologies such as Internet downloading and streaming, multimedia on mobile terminals, digital radio, video games, television and high-definition media (HDTV). This MPEG4 standard should enable convergence of the Web and television by integrating contents coming from both these media. It further offers the possibility of describing 2D interactive scenes through MHEG (Multimedia and Hymermedia Expert Group). MPEG4 is also used to define 3D scenes using VRML (Virtual Reality Modeling Language) to create Web scenes and to manage them using BIFS (Binary Format for Scene), the description being on the Web, the descriptive text that is associated with a page and displayed—usually the title of the page and its URL—when a user makes a request via a search engine or a directory. In the MPEG4 standard, the EAI (External Authoring Interface) programming interface should enable a VRML scene to be controlled from an external Java application. In the MPEG4 standard, a text description of the modules is provided under the name of OCI (Object Content Information), management of the network and terminals using the generic connection interface DMIF (Delivery Multimedia Framework).

In the technical field of interactive mobile services, standards other than MPEG4-BIFS have been proposed: MPEG-LASeR (Lightweight Application Scene Representation, promoted by Streamezzo), SVG (Scalable Vector Graphics, promoted by the World Wide Web Consortium (W3C)), MORE (Mobile Open Rich-Media Environment, promoted by Nokia).

To broadcast television to mobile terminals such as UMTS (Universal Mobile Telecommunications System) telephones, a cell supports a small number of simultaneous multimedia sessions at a high bit rate, typically 256 kbps. This capacity will undoubtedly be improved with the introduction of HSDPA (High Speed Downlink Packet Access) or 3GLTE (3GPP Long Term Evolution). The “broadcast” solution is not subject to this limitation, there being three possible technologies for broadcasting television to mobile terminals:
MBMS (Multimedia Broadcast/Multicast Service), an extension of the UMTS;
terrestrial digital networks such as DVB-H (Digital Video Broadcast transmission to Handheld terminals), T-DMB (Terrestrial Digital Multimedia Broadcasting), Media-Flo (Media Forward Link Only) and the Japanese network ISDB-T;
hybrid satellite/terrestrial networks such as S-DMB in Korea, MobaHO ! in Japan or DVB-H adapted to the S band, as developed by the applicant, providing a capacity for 5 to 11 Mbps (8 MHz) and 20 to 30 channels, compared to the three channels at 256 kbps of the MBMS.

One drawback of the “broadcast” approach is that each content creator supplies to the broadcaster a content obtained with the aid of their proprietary multimedia creation tools (authoring tools).

These creation tools make creating and delivering services flexible and easy, reducing design costs and the time necessary to bring a product to market.

Creation tools must take account of specific environments and the context of development and installation in the networks (deployment).

More precisely, the use of creation tools dedicated to the environments of mobile terminals and employed to create and deliver interactive mobile services must address the following two problems:
the dependency of these creation tools on multimedia formats or rich media formats. Multimedia formats such as MPEG4-BIFS (Moving Pictures and associated audio information coding Expert Group 4 Binary Format for Scene), MPEG4-LASeR, VRML (Virtual Reality Modeling Language), SVG (Scalable Vector Graphics) each offer a set of audiovisual descriptions and different graphic characteristics. The model describing the application is based on a language associated with a multimedia format. As an example of these differences, VRML is a “download and play” model, the content being downloaded entirely before the scene starts, while an MPEG-4 content can be a streaming model. The choice of another language implies translation of the source model to the target model. However, this translation is sometimes difficult because a few characteristics of one rich media language are not supported by another language. The rendering and behavior of the translated application may be affected by the translation process. As a result the choice of the creation tool governs the choice of the multimedia format. For example, the Streamezzo creation tool is dedicated to MPEG4 LASeR and does not support any other multimedia format. In the case of MPEG4-BIFS, the company Envivo proposes a creation tool supporting only the BIFS format (MPEG-4 H.263/H.264 encoders). The result of this is that to create an interactive mobile service supporting both the MPEG4-BIFS format and the MPEG4-LASeR format, it is necessary to employ two creation tools;
graphical appearance: there is no explicit method for reusing in a second service a graphical appearance defined for a first service. There is a strong need for a library of graphic appearances so that one of the appearances can be used by the defined service.

An object of the invention is to provide a solution to the problem of the dependency of creation tools on the multimedia format and enabling a graphical appearance to be reused to create services.

### SUMMARY OF THE INVENTION

To this end, a first aspect of the invention relates to a method of creating a multimedia service comprising:
a step of generic description, independent of the multimedia format, of the graphical charts employed for the service,
a step of generic description, independent of the multimedia format, of the elementary services of the service;
a step of merging of the generic description of the graphical charts and the generic description of the elementary services, to form a generic description of the service;
a step of choosing at least one target language;
a step of translation of the generic description of the service into the chosen target language.

Various implementations of the method have the following characteristics, which may where applicable be combined:
the step of translation of the generic description comprises a syntax analysis and an inference analysis;
for its description, an elementary service is considered as formed of three functional components: the component of rendition to the end user, the logical component of the internal service, where the logical part of the service is defined; the component of the external logical service, supporting interaction with a distant server;
when the service is translated into the target rich format, a compilation of the service is effected before deployment of the service.

A second aspect of the invention relates to a computer program product for multimedia service creation, the product comprising a service creation tool including means for merging a graphical chart description of the service and a description of elementary services to define a generic description of the service, independent of the multimedia format; this computer program product also including means for translating this generic service description into a target language.

The translation means advantageously comprise syntax analysis means associated with an inference engine.

The syntax analysis software advantageously comprises, as modules, an inference engine and multimedia format recognition means.

In an advantageous implementation, the inference engine module is configurable and defines the inference creation logical service. Accordingly, if a function in a created service is not supported by the target multimedia format, for example, the service creator can define how the translation will be effected to render that service at the same time as avoiding this weakness of the target multimedia format.

### BRIEF DESCRIPTION OF THE DRAWINGS

Other objects and advantages of the invention will appear in the course of the following description of implementations of the invention given with reference to the appended drawings, in which:

FIG. 1 is a diagrammatic view of the implementation of the invention;

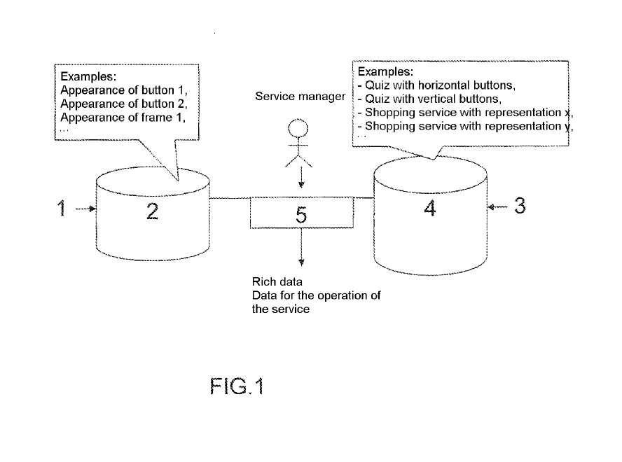

FIG. 2 is a diagrammatic view more detailed than that of FIG. 1;

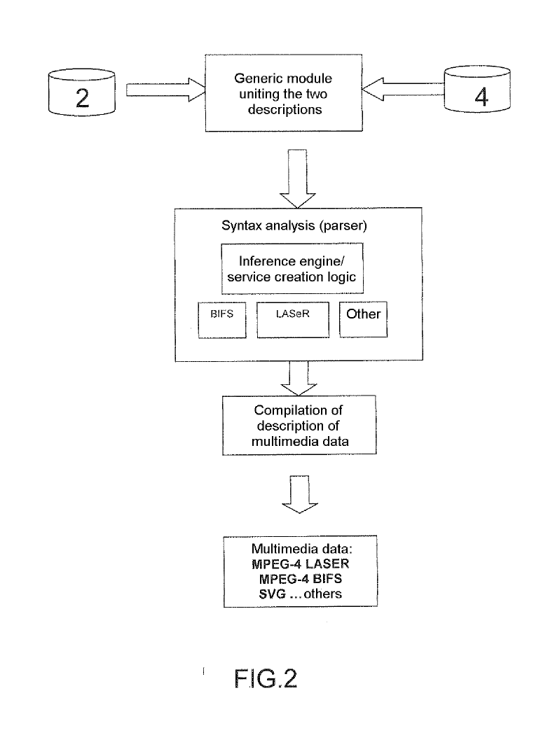

FIG. 3 is a diagrammatic view of one particular implementation of the invention.

### DETAILED DESCRIPTION OF PREFERRED EMBODIMENT

A multimedia format service consists of one or more elementary services such as canvassing, voting, quizzes, shopping. A graphical chart defines the appearance of this service, which is also linked to a server configuration component that defines the server end configuration.

When creating a service, a graphic creator 1 effects a description of the graphical charts employed for the service, and these descriptions are stored in a graphical charts database 2. The appearances of a collection of interface graphical elements (widgets) are defined, for example button style, combined zone (combo box), menu bar, scroll bar, text boxes, text style, line style.

In parallel with this, an elementary service creator 3 effects a description of the elementary services of the service (basic bricks), and these descriptions are stored in an elementary services descriptions database 4.

For its description, an elementary service is considered as formed of three functional components:
the component of rendition to the end user, for example abbreviated elements of an end user graphical interface GUI (Graphical User Interface);
the logical component of the internal service, in which the logical part of the service is defined. For example, detection of an event (button pressed) of an end user and execution of an action;
the component of the external logical service, supporting interaction with a remote server: client part for sending interactive requests from the end user terminal, server end for the management of these interactive requests.

A creation tool 5 produces a generic description of the service 6 from data extracted from the databases 2, 4.

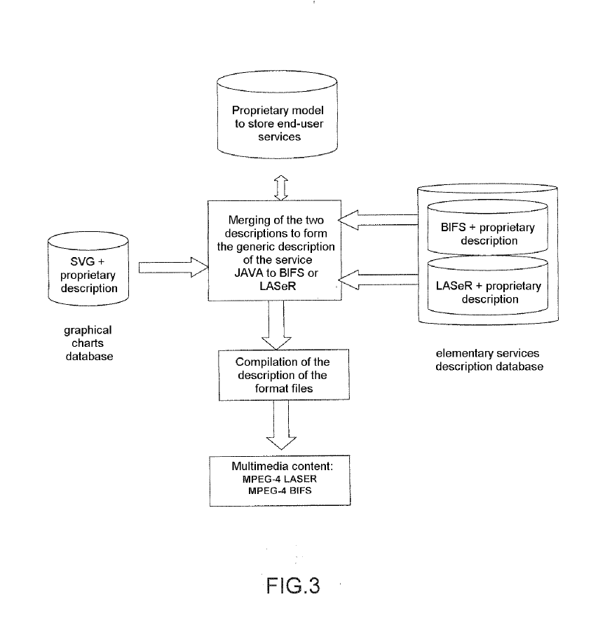

This description is referred to as generic in that it is independent of the multimedia format. The generic descriptions for the graphical chart or the services can be proprietary, for example, or defined in an existing multimedia format. For example, in the FIG. 3 implementation, the description of the graphical charts is specified in the SVG language and the descriptions of the elementary services are specified with BIFS and with LASeR.

The generic description of the service is sent to the syntax analysis (parser) software 7 for the translation of that generic description of the service into the required multimedia format.

The syntax analysis software 7 is associated with an inference engine (rule engine) 8 and translates a generic service description into a specific multimedia format, for example MPEG-4 BIFS, MPEG-4 LASeR, SVG, MORE.

This combination of syntax analysis software 7/inference engine 8 (parser/rule engine) for the translation of the generic description of the service takes account of the development and deployment context; for example:
is the multimedia format supported by the network operator and the equipments of the end users,
does the multimedia format support the service created.

An import function advantageously “converts” a service defined in a specific format into a generic description using the inference engine 8 for the adaptation.

In one implementation, the syntax analysis software 7 comprises, as modules:
an inference engine 8 (rule engine), and
multimedia format recognition software (rich media format parser).

The inference engine module 8 can be configured and defines the inference creation logical service. For example, if a function in a created service is not supported by the target multimedia format, the service creator can define how the translation will be effected to render that service at the same time as avoiding this weakness of the target multimedia format.

The format recognition module also takes into account the deployment context (for example the format is supported by the network and the equipments of the users).

The format recognition module is advantageously modular. For example, a format sub-module is defined for each format, enabling translation. If a new multimedia format appears on the market, format recognition can be adapted to integrate a sub-module dedicated to the new rich format.

When the service is translated into the target rich format, the service is compiled 9 before it is deployed 10 on the network of the operator.

To prevent the recreation of existing and deployed services, the multimedia service creation tool supports an important function for conversion of a service defined in a multimedia format into the generic model.

The service creator will have the possibility of inserting his own translation rule in order to adapt the conversion.

Using the invention offers numerous advantages:
avoiding conversion between multimedia formats such as BIFS or LASeR;
services are specified independently of the multimedia formats, and can be translated into any format;
after the specification of the services, the creation tools propose selection of the target multimedia format;
as far as possible, the services delivered to the end users have the same independence vis a vis the encoding of the multimedia format;
the same service can be defined in more than one rich media encoding according to the network operator and the end user equipment;
the creation tool can be updated to support a new multimedia format;
it is possible to import existing services.

The implementation of the invention for contents and services is thus highly advantageous for providers and operators (telco and broadcasting) who do not wish to define a service using multiple skills in terms of tools and rich formats.

### Key

1 graphic creator
2 graphical charts database
3 elementary services creator
4 elementary services descriptions database
5 creation tool
6 generic service description
7 syntax analysis software
8 inference engine
9 compilation
10 deployment

1. Method of creation of a multimedia service, this method comprising:
a step of generic description of the interface graphical elements employed for the service, this description being specified in a first language such as SVG;
a step of storing these descriptions in a graphical charts database;
a step of generic description of the elementary services of the service such as canvassing, voting, quizzes, shopping, this description being specified in a second language such as BIFS or LASeR, in the form of three functional components: component of rendition to the end user such as abbreviated elements of a graphical interface; internal service logical component; logical component of the external service supporting interaction with a remote server;
a step of storing of these descriptions in an elementary services description database;
a step of merging of the generic description of the interface graphical elements and the generic description of the elementary services to form a generic description of the service;
a step of choice of at least one target rich media format such as MPEG-4 BIFS, MPEG-4 LASeR, SVG, MORE;
a step of translation, by syntax analysis software associated with an inference engine, of the generic description of the service into the chosen rich media format.

2. Service creation method according to claim 1, wherein, when the service is translated into the target rich format, compilation of the service is effected before deployment of the service on the network of the operator.

3. Service creation method according to claim 1, wherein, for its description, an elementary service is considered as formed of three functional components:
the component of rendition to the end user,
the logical component of the internal service, in which the logical part of the service is defined;
the component of the external logical service, supporting interaction with a remote server.

4. Service creation method according to claim 1, wherein, when the service is translated into the target rich format, compilation of the service is effected before deployment of the service.

5. Computer program product for the creation of multimedia services, this product including a service creation tool having:
means for merging a graphical chart description of the service and an elementary service description to define a generic description of the service independent of the multimedia format;
means for translation of this service generic description into a target language.

6. Computer program product according to claim 5, wherein the translation means comprise syntax analysis means associated with an inference engine.

7. Computer program product according to claim 5, wherein the syntax analysis software comprises, as modules, an inference engine and multimedia format recognition means.

8. Computer program product according to claim 7, wherein the inference engine module is configurable and defines the inference creation logical service.
